(19) United States
(12) Patent Application Publication
(10) Pub. No.: US 2024/0429658 A1
(43) Pub. Date: Dec. 26, 2024

(54) Cable Connector Assembly, Organizer and Terminal Assembly

(71) Applicants: Tyco Electronics (Dongguan) Ltd., Dongguan City (CN); Tyco Electronics (Shanghai) Co., Ltd., Shanghai (CN)

(72) Inventors: Lizhou (Leo) Li, Shanghai (CN); Xinjie (David) Zhang, Shanghai (CN); Yongfeng Li, Dongguan (CN)

(73) Assignees: Tyco Electronics (Dongguan) Ltd., Dongguan City (CN); Tyco Electronics (Shanghai) Co., Ltd., Shanghai (CN)

(21) Appl. No.: 18/748,608

(22) Filed: Jun. 20, 2024

(30) Foreign Application Priority Data
Jun. 20, 2023 (CN) 202310738769.2

(51) Int. Cl. H01R 13/6471; H01R 12/72; H01R 12/75

(52) U.S. Cl. CPC H01R 13/6471; H01R 12/727; H01R 12/75; H01R 2201/06

(57) ABSTRACT

A cable connector assembly includes a connector housing, a plurality of connection terminals, a plurality of cables, and an organizer. The plurality of connection terminals are arranged in the connector housing. Each of the plurality of cables includes at least one pair of signal wires. The organizer is arranged between the plurality of connection terminals and the plurality of cables. The signal wires of the plurality of cables are connected to the corresponding connection terminals at the organizer.

### CROSS-REFERENCE TO RELATED APPLICATION

This application claims the benefit of Chinese Patent Application No. CN 202310738769.2 filed on Jun. 20, 2023, in the China National Intellectual Property Administration, the whole disclosure of which is incorporated herein by reference.

### FIELD OF THE INVENTION

Embodiments of the present disclosure generally relate to electrical connectors, and in particular, to a cable connector assembly, an organizer, and a terminal assembly.

### BACKGROUND

In the related art, a connection between a peripheral component interconnect express (PCIe) connector and a cable is achieved by an interposer printed circuit board. The connector is soldered on the printed circuit board and the cable is soldered on the printed circuit board to achieve cable connection between this connector and another mating electrical connector. In practice, a connection terminal of the connector is connected to the printed circuit board by a via or via hole. In order to ensure signal integrity (SI) during signal transmission (especially high-speed signal transmission), the material and process requirements of the printed circuit board and its via hole are very high, thus the cost associated with these arrangements is also high. In addition, in the related art, the connection between a high-speed signal connection terminal of the connector and a signal wire of the cable leads to high impedance and signal crosstalk during high-speed signal transmission.

### SUMMARY

According to an embodiment of the present disclosure, a cable connector assembly includes a connector housing, a plurality of connection terminals, a plurality of cables, and an organizer. The plurality of connection terminals are arranged in the connector housing. Each of the plurality of cables includes at least one pair of signal wires. The organizer is arranged between the plurality of connection terminals and the plurality of cables. The signal wires of the plurality of cables are connected to the corresponding connection terminals at the organizer.

### BRIEF DESCRIPTION OF THE DRAWINGS

The invention will now be described by way of example with reference to the accompanying Figures, of which:

FIG. 1 is a schematic structure view of a cable connector assembly according to an exemplary embodiment of the present disclosure;

FIG. 2 is a schematic exploded structure view of the cable connector assembly shown in FIG. 1;

FIG. 3 is a schematic partial structure view of the cable connector assembly shown in FIG. 1;

FIG. 4 is a schematic partial structure view of an organizer of the cable connector assembly shown in FIG. 1;

FIG. 5 is a schematic partial structure view of the cable connector assembly shown in FIG. 1;

FIG. 6 is a schematic partial structure view of a connector housing of the cable connector assembly shown in FIG. 1;

FIG. 7 is a schematic partial structure view of the organizer of the cable connector assembly shown in FIG. 1;

FIG. 8 is a schematic structure view of a connection terminal of the cable connector assembly shown in FIG. 1; and

FIG. 9 is a schematic structure view of a plurality of connection terminals of the cable connector assembly shown in FIG. 1.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a cable connector assembly, includes a connector housing, a plurality of connection terminals, a plurality of cables, and an organizer. The plurality of connection terminals are arranged in the connector housing. The organizer is arranged between the plurality of connection terminals and the plurality of cables. Each of the plurality of cables includes at least one pair of signal wires. The signal wires of the plurality of cables are connected to respective corresponding connection terminals at the organizer.

According to another embodiment of the present disclosure, an organizer for connecting a cable connector is provided. The cable connector includes a plurality of connection terminals and a plurality of cables. The organizer is provided between the plurality of connection terminals and the plurality of cables. Signal wires of the plurality of cables are connected to corresponding connection terminals at the organizer.

According to yet another embodiment of the present disclosure, a terminal assembly for a cable connector includes a plurality of sets of connection terminals. Each set of connection terminals includes a pair of signal terminals, and a pair of ground terminals positioned on opposite sides of the pair of signal terminals. In each set of connection terminals, a spacing between at least a portion of a middle portion of the pair of signal terminals is greater than a spacing between a remainder of the middle portion of the pair of signal terminals.

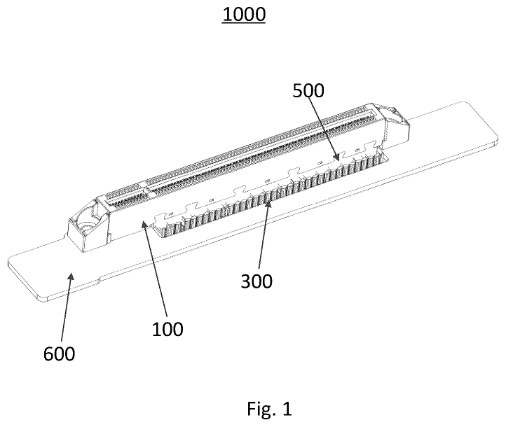

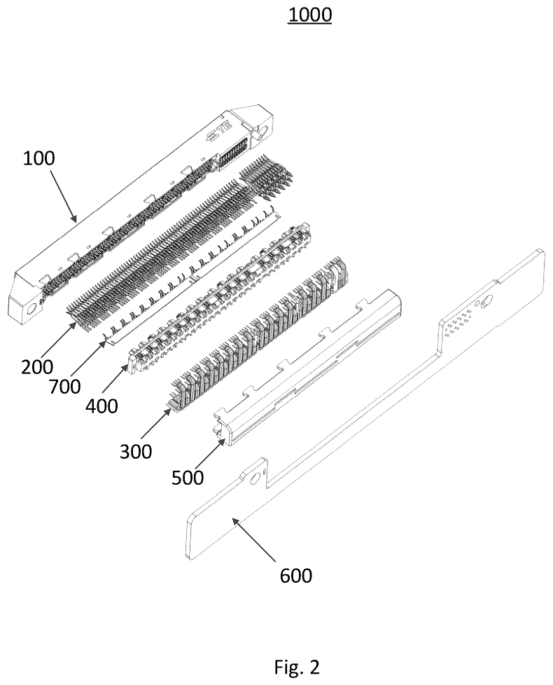

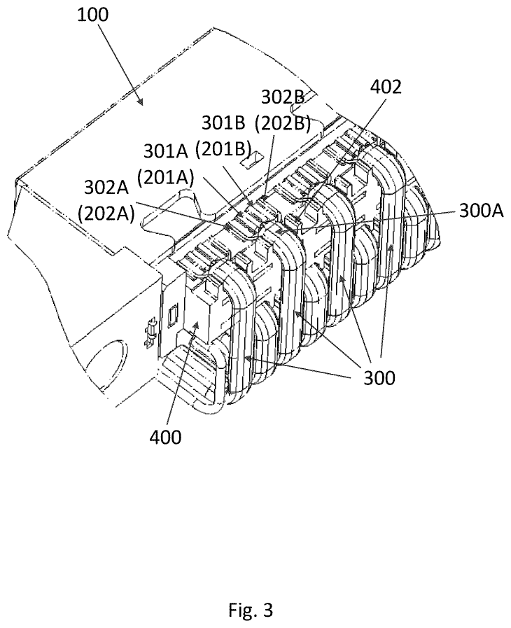

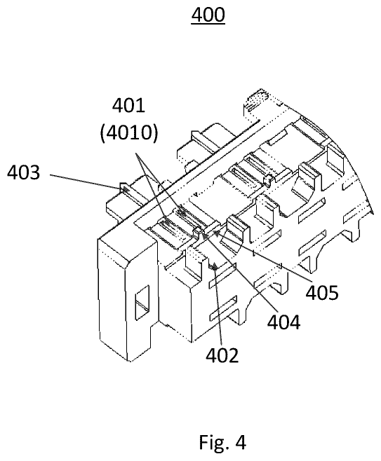

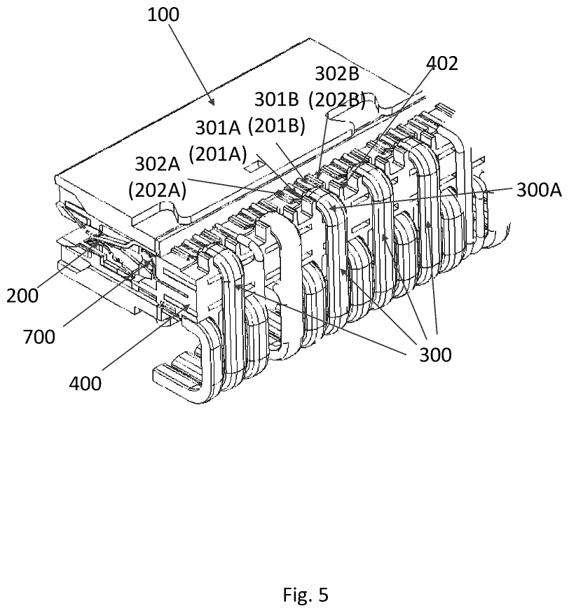

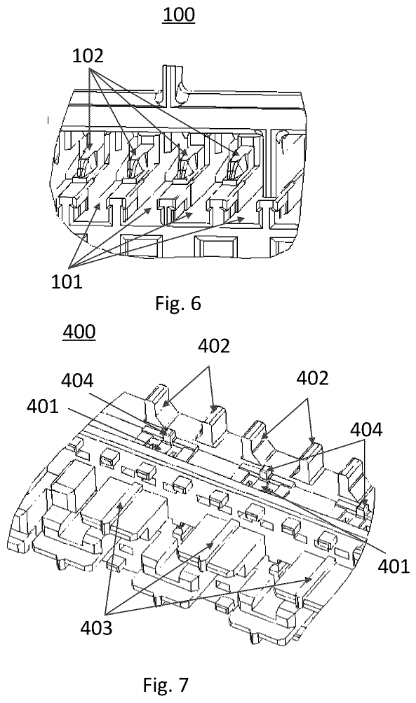

FIG. 1 is a schematic structure view of a cable connector assembly according to an exemplary embodiment of the present disclosure. FIG. 2 is a schematic exploded structure view of the cable connector assembly shown in FIG. 1. FIG. 3 is a schematic partial structure view of the cable connector assembly shown in FIG. 1, wherein an over-molding member is omitted and a connection structure between connection terminals and cables at an organizer is showed. FIG. 4 is a schematic partial structure view of the organizer of the cable connector assembly shown in FIG. 1, which mainly shows a structure of a cable side of the organizer. FIG. 5 is a schematic partial structure view of the cable connector assembly shown in FIG. 1, wherein an over-molding member is omitted and an arrangement status of the connection terminals inside a connector housing and the connection structure between the connection terminals and the cables at the organizer are showed. FIG. 6 is a schematic partial structure view of the connector housing of the cable connector assembly shown in FIG. 1, showing an internal structure of the connector housing. FIG. 7 is a schematic partial structure view of the organizer of the cable connector assembly shown in FIG. 1, showing a structure of a terminal side of the organizer.

Referring to FIGS. 1-7, according to the present disclosure, a cable connector assembly 1000 is provided. As shown in FIGS. 1 and 2, the cable connector assembly 1000 includes a connector housing 100, a plurality of connection terminals 200, a plurality of cables 300, an organizer 400, an over-molding member 500, a printed circuit board 600, and a ground sheet 700. According to the exemplary embodiments, in the cable connector assembly 1000 provided by the present disclosure, the plurality of connection terminals 200 are arranged side by side in the connector housing 100. One end of each connection terminal 200 is adapted to be connected to a connection terminal of a mated connector (not shown), and the other end is directly connected to a corresponding signal wire or ground wire of the cable 300.

According to the present disclosure, as shown in FIG. 3, the plurality of connection terminals 200 further include a plurality of sets of connection terminals arranged side by side (four sets are shown in FIG. 3). Each set of connection terminals includes a pair of signal terminals 201A, 201B, and a pair of ground terminals 202A, 202B positioned on opposite sides of the pair of signal terminals 201A, 201B. Correspondingly, in the cable connector assembly 1000 provided by the present disclosure, as shown in FIG. 3, each of the plurality of cables 300 (four cables 300 are shown in FIG. 3) includes a pair of signal wires 301A, 301B and a pair of ground wires 302A, 302B, wherein the pair of ground wires 302A, 302B are positioned on opposite sides of the pair of signal wires 301A, 301B. The pair of signal terminals 201A, 201B and the pair of ground terminals 202A, 202B of each set of connection terminals are directly connected to the pair of signal wires 301A, 301B and the pair of ground wires 302A, 302B of each cable 300, respectively. According to the present disclosure, the connection terminals for high-speed signal transmission of the connector are directly connected to the cables, avoiding connections of the terminals to the cables by via holes in the printed circuit board, thereby improving SI performance and reducing costs.

In the cable connector assembly 1000 provided by the exemplary embodiments of the present disclosure, the organizer 400 is provided between the plurality of connection terminals 200 and the plurality of cables 300, wherein the signal wires 301A, 301B and the ground wires 302A, 302B of the plurality of cables 300 are connected to the corresponding connection terminals 201A, 201B, 202A, 202B at the organizer 400, respectively. The organizer 400 can, for example, be made of an electrical insulating material, such as plastic.

Specifically, as shown in FIGS. 3-5 and 7, in the cable connector assembly 1000 provided by the exemplary embodiments of the present disclosure, the organizer 400 includes a connection portion 401. The connection portion 401 is formed between a terminal side (such as the upper left side in FIG. 4) and a cable side (such as the lower right side in FIG. 4) of the organizer 400, and adapted to connect the signal wires 301A, 301B and the corresponding connection terminals 200 with each other at the connection portion 401 (such as by soldering or other manners, such as plugging, crimping, etc.).

As shown in FIG. 4, the connection portion 401 is provided with a positioning groove 4010. As shown in FIG. 5, the connection terminal 200 is positioned above the positioning groove 4010 of the connection portion 401, and the signal wires 301A, 301B and the ground wires 302A, 302B are positioned above the corresponding connection terminals 200, respectively. More specifically, as shown in FIG. 4, at the connection portion 401 for the signal wires 301A, 301B, a penetrating opening is formed at the positioning groove 4010. The impedance between each pair of signal wires can be optimized by forming the positioning grooves with the penetrating openings at the connection portions of each pair of signal wires 301A, 301B, thereby improving high-speed signal transmission.

In the cable connector assembly 1000 provided by the exemplary embodiments of the present disclosure, the organizer 400 further includes a cable holding portion 402. For example, referring to FIGS. 3 and 4, the cable holding portion 402 is formed at a position of the connection portion 401 close to the cable side, and is configured to hold an end portion 300A of each cable 300 in place in the organizer 400 to facilitate connections between the pair of signal wires 301A, 301B extending from the end portion 300A of the cable 300 and the corresponding connection terminals 200 at the connection portion 401. The cable 300 can be stably held on the organizer 400 after being bent by providing the cable holding portion 402, so that the signal wires 301A, 301B of the cable 300 can be stably connected to the corresponding connection terminals 200 at the connection portion 401 (such as by soldering or other manners, such as plugging, crimping, etc.).

In the cable connector assembly 1000 provided by the exemplary embodiments of the present disclosure, the organizer 400 further includes a signal wire separating portion 404. For example, as shown in FIG. 4, the signal wire separating portion 404 is formed between the connection portion 401 and the cable holding portion 402 and is configured to separate the pair of signal wires 301A, 301B that extend from the end portion 300A of each cable 300 from each other at the end portion 300A of each cable 300. The impedance between each pair of signal wires 301A, 301B can be optimized by providing the cable holding portion 402, thereby improving high-speed signal transmission.

The organizer 400 further includes a dam portion 405. For example, as shown in FIG. 4, the dam portion 405 is formed between the connection portion 401 and the cable holding portion 402 and is configured to prevent the overflow of adhesive (such as UV cured adhesive), thereby avoiding adverse effects of the adhesive on the effective connection between the cable 300 and the connection terminals 200. In addition, the signal wire separating portion 404 may be positioned above the dam portion 405.

The organizer 400 has a terminal separating portion 403. The terminal separating portion 403 is formed on the terminal side of the organizer 400 and is configured to separate the adjacent connection terminals 200 from each other. As shown in FIG. 4, the terminal separating portion 403 can be in the form of a rib. The impedance between each pair of signal wires 301A, 301B can be optimized by providing the terminal separating portion 403, thereby improving high-speed signal transmission.

Specifically, as shown in FIG. 6, in the cable connector assembly 1000 provided by the exemplary embodiments of the present disclosure, the connector housing 100 includes a plurality of terminal accommodating grooves 101 and an isolation rib 102. The plurality of terminal accommodating grooves 101 are formed inside the connector housing 100 and are configured to accommodate respective ones of the plurality of connection terminals 200, as shown in FIG. 5. The isolation rib 102 is formed between every two adjacent terminal accommodation grooves 101 and is configured to isolate the connection terminals 200 positioned in the two adjacent terminal accommodation grooves 101 from each other. The impedance between each pair of signal terminals 201A, 201B can be optimized by providing the isolation rib 102 inside the connector housing 100, thereby improving high-speed signal transmission.

In addition, according to the present disclosure, as shown in FIGS. 1-7, the cable connector assembly 1000 further includes a ground sheet 700. For example, as shown in FIG. 5, the ground sheet 700 is provided at the organizer 400. The ground sheet 700 is in contact with all ground wires 302A, 302B of the plurality of cables 300. The crosstalk can be reduced by providing the ground sheet 700 to connect all ground wires 302A, 302B of the plurality of cables 300, thereby improving high-speed signal transmission.

In addition, according to the present disclosure, in the cable connector assembly 1000, the connections between the plurality of connection terminals 200 and the plurality of cables 300 at the organizer 400 are wrapped together by the over-molding member 500. This ensures the stable connections between the cables 300 and the connection terminals 200. Moreover, the connector housing 100 is positioned on the printed circuit board 600.

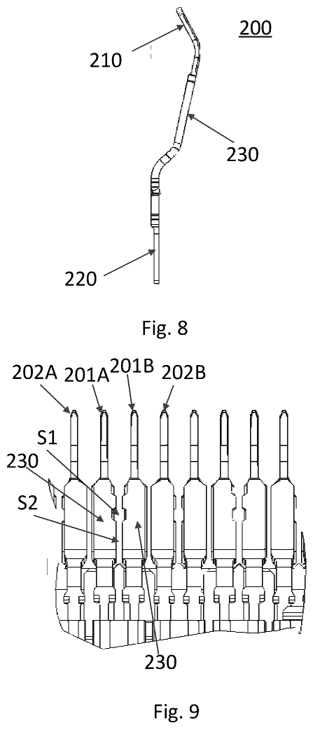

FIG. 8 is a schematic structure view of a connection terminal of the cable connector assembly shown in FIG. 1. FIG. 9 is a schematic structure view of a plurality of connection terminals of the cable connector assembly shown in FIG. 1.

According to the present disclosure, as shown in FIGS. 8 and 9, each connection terminal 200 includes a first end portion 210, a second end portion 220, and a middle portion 230 connecting the first end portion 210 and the second end portion 220. Specifically, as shown in FIG. 8, a thickness of the middle portion 230 is greater than those of the first end portion 210 and the second end portion 220. In this way, the connection terminal 200 adopts a design of “thick in the middle and thin at both ends”, which can optimize the impedance between each pair of signal terminals 201A, 201B, thereby improving high-speed signal transmission.

More specifically, as shown in FIG. 9, the plurality of connection terminals 200 further include a plurality of sets of connection terminals. Each set of connection terminals includes a pair of signal terminals 201A, 201B and a pair of ground terminals 202A, 202B positioned on opposite sides of the pair of signal terminals 201A, 201B, respectively. In each set of connection terminals, a spacing S1 between at least a portion of the middle portion 230 of the pair of signal terminals 201A, 201B is greater than a spacing S2 between the rest of the middle portion 230 of the pair of signal terminals 201A, 201B. In this way, the impedance between each pair of signal terminals 201A, 201B can be optimized by increasing the spacing between a portion of each pair of signal terminals 201A, 201B, thereby improving high-speed signal transmission.

According to the aforementioned exemplary embodiments provided by the present disclosure, the cable connector assembly has improved impedance and optimized signal crosstalk phenomenon during high-speed signal transmission.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cable connector assembly, comprising:
a connector housing;
a plurality of connection terminals arranged in the connector housing;
a plurality of cables, each comprising at least one pair of signal wires; and
an organizer arranged between the plurality of connection terminals and the plurality of cables, wherein the signal wires of the plurality of cables are connected to the corresponding connection terminals at the organizer.

2. The cable connector assembly according to claim 1, wherein the organizer comprises a connection portion formed between a terminal side and a cable side of the organizer, the connection portion adapted to connect the signal wires and the corresponding connection terminals with each other at the connection portion, and including a positioning groove, the connection terminals are positioned above the positioning groove and the signal wires are positioned above respective corresponding connection terminals.

3. The cable connector assembly according to claim 2, wherein a penetrating opening is formed at the positioning groove.

4. The cable connector assembly according to claim 2, wherein the organizer further comprises a cable holding portion formed at the connection portion proximate to the cable side, the cable holding portion adapted to hold an end portion of each cable in place within the organizer.

5. The cable connector assembly according to claim 4, wherein the organizer further comprises a signal wire separating portion formed between the connection portion and the cable holding portion, the signal wire separating portion adapted to separate the pair of signal wires extending from the end portion of each cable from each other.

6. The cable connector assembly according to claim 5, wherein the organizer further includes a dam portion formed between the connection portion and the cable holding portion, and adapted to prevent an overflow of adhesive, the signal wire separating portion is positioned above the dam portion.

7. The cable connector assembly according to claim 2, wherein the organizer further includes a terminal separating portion formed at the terminal side of the organizer, and adapted to separate adjacent connection terminals from each other.

8. The cable connector assembly according to claim 1, wherein the connector housing comprises:
a plurality of terminal accommodating grooves formed inside the connector housing, and adapted to accommodate respective ones of the plurality of connection terminals; and
an isolation rib formed between every two adjacent terminal accommodating grooves, and adapted to isolate the connection terminals positioned in the two adjacent terminal accommodating grooves from each other.

9. The cable connector assembly according to claim 1, further comprising a ground sheet provided at the organizer, each cable further includes a pair of ground wires positioned on opposite sides of the pair of signal wires, the ground sheet in contact with all ground wires of the plurality of cables.

10. The cable connector assembly according to claim 1, wherein each connection terminal includes a first end portion, a second end portion, and a middle portion connecting the first end portion and the second end portion, a thickness of the middle portion is greater than thicknesses of the first end portion and the second end portion.

11. The cable connector assembly according to claim 10, wherein:
the plurality of connection terminals further comprise a plurality of sets of connection terminals, each set of connection terminals comprising a pair of signal terminals and a pair of ground terminals positioned on opposite sides of the pair of signal terminals; and
in each set of connection terminals, a spacing between at least a portion of the middle portion of the pair of signal terminals is greater than a spacing between a remainder of the middle portion of the pair of signal terminals.

12. The cable connector assembly according to claim 1, wherein the organizer is made of electrically insulating material.

13. The cable connector assembly according to claim 1, further comprising an over-molded member wrapping together connections between the plurality of connection terminals and the plurality of cables at the organizer.

14. The cable connector assembly according to claim 1, further comprising a printed circuit board on which the connector housing is arranged.

15. An organizer for a cable connector having a plurality of connection terminals and a plurality of cables, comprising:
a connection portion formed between a terminal side and a cable side of the organizer, and adapted to connect signal wires of the plurality of cables to corresponding ones of the plurality of connection terminals at the connection portion.

16. The organizer according to claim 15, wherein:
the connection portion defines a positioning groove;
the connection terminal is positioned above the positioning groove of the connection portion; and
the signal wires are positioned above corresponding respective ones of the connection terminals.

17. The organizer according to claim 16, wherein a penetrating opening is formed at the positioning groove.

18. The organizer according to claim 16, further comprising a cable holding portion formed at a position of the connection portion proximate to the cable side, and adapted to hold an end portion of each cable in place within the organizer.

19. The organizer according to claim 18, further comprising a signal wire separating portion formed between the connection portion and the cable holding portion, and adapted to separate the pair of signal wires extending from the end portion of each cable from each other at the end portion of each cable.

20. The organizer according to claim 19, further comprising a dam portion formed between the connection portion and the cable holding portion and adapted to prevent an overflow of adhesive, wherein the signal wire separating portion is positioned above the dam portion.

21. The organizer according to claim 16, further comprising a terminal separating portion formed on the terminal side of the organizer, and separating the adjacent connection terminals from each other.

22. The organizer according to claim 15, wherein the organizer is made of electrically insulating material.

23. A terminal assembly for a cable connector, comprising:
a plurality of connection terminals including a plurality of sets of connection terminals, each set of connection terminals comprising a pair of signal terminals and a pair of ground terminals positioned on opposite sides of the pair of signal terminals, wherein in each set of connection terminals, a spacing between at least a portion of a middle portion of the pair of signal terminals is greater than a spacing between a remainder of the middle portion of the pair of signal terminals.

24. The terminal assembly as claimed in claim 23, wherein:
each connection terminal includes a first end portion, a second end portion, and a middle portion connecting the first end portion and the second end portion; and
a thickness of the middle portion is greater than thicknesses of the first end portion and the second end portion.
